(19) United States
(12) Patent Application Publication
(10) Pub. No.: US 2021/0358331 A1
(43) Pub. Date: Nov. 18, 2021

(54) BRAILLE MEMO DEVICE

(71) Applicant: OVERFLOW BIZ, INC., Seoul (KR)

(72) Inventors: Sang Eon KIM, Seoul (KR); Hyeon Gyu PARK, Seoul (KR)

(73) Assignee: OVERFLOW BIZ, INC.

(21) Appl. No.: 17/385,502

(22) Filed: Jul. 26, 2021

Related U.S. Application Data
(63) Continuation of application No. PCT/KR2020/003725, filed on Mar. 18, 2020.

(30) Foreign Application Priority Data
Dec. 9, 2019 (KR) 10-2019-0163126

(51) Int. Cl. G09B 21/02

(52) U.S. Cl. CPC G09B 21/02

(57) ABSTRACT

According to an embodiment, a braille slate may include a housing having a space in an interior thereof, a plurality of braille pin pressing parts disposed in rows and columns when one side wall of the housing is viewed, a plurality of braille pins disposed in rows and columns in the braille pin pressing parts and pressed through a pressing operation from an opposite side wall toward the one side wall of the housing to be locked on the braille pin pressing parts such that ends thereof protrude from the one side wall of the housing, a stylus provided on an outer side of the housing and that performs a pressing operation of pressing the braille pins, and an unlocking member that unlocks the braille pins by applying a force from the one side wall toward the opposite side wall to move the braille pins toward the opposite side wall.

### CROSS REFERENCES TO RELATED APPLICATION

This application is a continuation of PCT/KR2020/003725, filed Mar. 18, 2020, which claims priority to KR 10-2019-0163126, the entire disclosure of which is incorporated herein by reference.

### TECHNICAL FIELD

The inventive concept relates to a braille slate, and more particularly, to a braille slate by which a visually handicapped person may read and write a braille.

### BACKGROUND ART

A braille is a letter for a visually handicapped person, and refers to a protrusion in a form of a point on a paper surface or a planar surface such that a totally blind or deaf visually handicapped person or a visually handicapped person with a low vision may identify a letter. A visually handicapped person may contact a protruding braille with an end of a finger or recognize meanings of letters and symbols in the braille. The braille may express letter, abbreviations defined in advance, and numbers by using four, six, or eight dots for braille.

An existing braille tool for a visually handicapped person includes a wooden board, a slate, and a stylus. The existing braille tool cannot read and write the braille without using paper, which causes environmental restrictions.

Furthermore, the existing braille tool is considerably bothersome when the braille has to be continuously identified while the braille is written. For example, when a visually handicapped person solves a mathematic problem such as an equation, he or she also has to solve mathematical formulas on paper as if a non-handicapped person cannot solve the mathematic problem in mental arithmetic.

Then, he or she has to continuously identify the braille while expressing the mathematic formulas with braille, and the paper has to be turned over so that he or she may read the braille after fitting the paper with the wooden board and writing the braille.

Furthermore, when a menu for a visually handicapped person is provided in a restaurant, separate costs have to be spent when the braille menu is manufactured separately, and it is difficult to manage the braille menu and high costs may be consumed to additionally manufacture the braille menu whenever menus are changed because it is difficult to correct the braille menu.

### DETAILED DESCRIPTION OF THE INVENTION

### Technical Problem

The inventive concept provides a braille slate by which a braille may be read and written without using separate paper, and which may initialize an input braille and has a function of immediately correcting a type of a braille.

The inventive concept also provides a braille slate that may maintain written contents.

### Technical Solution

The inventive concept provides a braille slate. According to an embodiment, a braille slate includes a housing having a space in an interior thereof, a plurality of braille pin pressing parts disposed in rows and columns when one side wall of the housing is viewed, a plurality of braille pins disposed in rows and columns in the braille pin pressing parts and pressed through a pressing operation from an opposite side wall toward the one side wall of the housing to be locked on the braille pin pressing parts such that ends thereof protrude from the one side wall of the housing, a stylus separately provided on an outer side of the housing and that performs a pressing operation of pressing the braille pins, and an unlocking member that unlocks the braille pins by applying a force from the one side wall toward the opposite side wall to move the braille pins toward the opposite side wall in a state, in which the braille pins are locked.

Each of the braille pins may include a head formed at the end thereof, a neck extending from the head in a direction toward the opposite side wall and recessed more inwards than the head, a shoulder extending from the neck in the direction toward the opposite side wall and protruding more outwards than the neck, a body extending from the shoulder from the shoulder in the direction toward the opposite side wall, a waist extending from the second body in the direction toward the opposite side wall, and a leg extending from the waist in the direction toward the opposite side wall and recessed more inwards than the waist, the braille pin pressing part may include a braille pin hole formed on the one side wall such that the head passes therethrough, a braille pin through portion extending from the one side wall in the direction toward the opposite side wall and surrounding the braille pin hole, a locking boss protruding from an inner surface of the braille pin through portion, and a braille pin window formed such that the leg is inserted into the opposite side wall and inner and outer sides of which are passed through, the braille pin window may be sized such that the leg is inserted thereinto and the waist is caught thereby, and the neck may be engaged with the locking boss in a state, in which the braille pin is locked.

The locking boss may have an inclined surface, by which the locking boss is inclined to be thinner as it goes in a protruding direction, at a corner of an end in the protruding direction.

The second body may be recessed more inwards than the shoulder or a side surface of the second body coincides with a side surface of the shoulder when viewed along a lengthwise direction of the braille pin, an end of the waist may protrude more outwards than the second body to be located outwardly farther than an end of the shoulder, the unlocking member may include an unlocking plate having a through-hole, through which the braille pin passes, and located between the braille pin through portion and the waist, an unlocking button extending to pass through the one side wall from the unlocking plate and protrudes outwards, and an elastic member that applies an elastic force to the unlocking plate in a direction toward the one side wall, and the through-hole may be sized such that the shoulder passes therethrough and the waist is caught thereby.

Opposite ends of the unlocking plate may correspond to one end area of an edge area of the housing, which surrounds an area in which the braille pin pressing parts are disposed, and an opposite end area that is an opposite area to the one end area, and the unlocking buttons may be formed at the opposite ends of the unlocking plate.

A rib extending from a surface facing the one side wall along an area, except for an area corresponding to the braille pin pressing parts, may be provided in the unlocking plate.

A plurality of unlocking members may be provided to correspond to a plurality of areas obtained by dividing the area of the housing, in which the braille pin pressing parts are disposed.

A guide extending in the direction toward the one side wall may be formed in the opposite side wall, a guide hole, through which the guide passes, may be formed in the unlocking plate such that the unlocking plate is moved along the guide, and the guide may be integrally formed with the housing.

A separation preventing part that extends in the direction of the one side wall and prevents the unlocking plate from deviating in the direction of the one side wall by a specific distance or more may be formed in the opposite side wall, a separate preventing hole, through which the separation preventing part passes such that the unlocking plate is moved along the separation preventing part, may be formed in the unlocking plate, a stop boss extending outwards not to pass through the separation preventing hole may be formed at an end of the separation preventing part, and the separation preventing part may be integrally formed with the housing.

A support extending in a direction toward the one side wall to surround the braille pin window included in the braille pin pressing part may be formed in the opposite side wall, and the support may be sized such that a hole formed by an inner surface thereof contacts or is adjacent to a side surface of the leg in a state, in which the leg is inserted into the braille pin window.

### Advantageous Effects of the Invention

The braille slate according to the embodiment of the inventive concept may be used to allow a visually handicapped person to read and write a braille without using separate paper.

Furthermore, the braille slate according to the embodiment of the inventive concept may initialize an input braille and immediately correct a type of a braille.

Furthermore, the braille slate according to the embodiment of the inventive concept may maintain written contents. Accordingly, the braille slate may be used for a menu for a visually handicapped person in a restaurant.

### DESCRIPTION OF THE DRAWINGS

FIG. 1 is a perspective view illustrating one side wall of a braille slate according to an embodiment of the inventive concept;

FIG. 2 is a perspective view illustrating an opposite side wall of the braille slate of FIG. 1;

FIG. 3 is a plan view illustrating an interior of a first housing of FIG. 1;

FIG. 4 is a plan view illustrating an interior of a second housing of FIG. 1;

FIG. 5 is a side cross-sectional view illustrating a part of the braille slate of FIG. 1, which is cut such that a braille pin in an unlocked state is viewed;

FIG. 6 is a perspective view of the braille pin illustrated in FIG. 5;

FIG. 7 is a perspective view illustrating a braille pin hole, a braille pin through portion, and a locking boss illustrated in FIG. 3;

FIG. 8A is a perspective view illustrating another example of the braille pin hole, the braille pin through portion, and the locking boss illustrated in FIG. 3;

FIG. 8B is a perspective view illustrating still another example of the braille pin hole, the braille pin through portion, and the locking boss illustrated in FIG. 3;

FIG. 8C is a perspective view illustrating yet another example of the braille pin hole, the braille pin through portion, and the locking boss illustrated in FIG. 3;

FIG. 9 is a perspective view illustrating still yet another example of the braille pin hole, the braille pin through portion, and the locking boss illustrated in FIG. 3;

FIG. 10 is a perspective view illustrating a state, in which a braille pin window illustrated in FIG. 2 is viewed from an inner side;

FIG. 11 is a perspective view illustrating a state, in which a braille pin window illustrated in FIG. 2 is viewed from an outer side;

FIG. 12 is a perspective view illustrating an example of an unlocking plate illustrated in FIG. 5;

FIG. 13 is a perspective view illustrating an example of a state, in which the unlocking plate of FIG. 12 is disposed in a second housing;

FIG. 14 is a side cross-sectional view illustrating a part of the braille slate of FIG. 1, which is cut such that the unlocking plate in a raised state is viewed;

FIG. 15 is a perspective view illustrating a guide illustrated in FIG. 4;

FIG. 16 is a partially perspective view illustrated an example of a stylus and a stylus hole illustrated in FIG. 2;

FIG. 17 is a side cross-sectional view illustrating a part of the braille slate of FIG. 1, which is cut such that the braille pin in a locked state is viewed;

FIG. 18 is a side cross-sectional view illustrating a part of the braille slate of FIG. 1, which is cut such that the braille pin unlocked by the unlocking plate is viewed; and

FIG. 19 is a side cross-sectional view illustrating a part of the braille slate of FIG. 1, which is cut such that the unlocking plate in a lowered state is viewed.

### BEST MODE

The inventive concept can be variously transformed and various embodiments are possible, and specific embodiments will be illustrated in the drawings and the detailed description thereof in detail. However, the embodiments according to the concept of the inventive concept are not intended to limit the specific disclosed forms, and it should be understood that the present inventive concept includes all transforms, equivalents, and replacements included in the spirit and technical scope of the inventive concept. In a description of the inventive concept, a detailed description of related known technologies may be omitted when it may make the essence of the inventive concept unclear.

The terms such as first and second may be used to describe various elements, but the elements are not limited to the terms. The terms may be used only for the purpose of distinguishing one element from another element.

The terminologies used herein are provided only to describe specific embodiments, and are not intended to limit the inventive concept. The terms of a singular form may include plural forms unless otherwise specified. The terms “including” and “having” are used to designate that the features, the numbers, the steps, the operations, the elements, the parts, or combination thereof described in the specification are present, and may be understood that one or more other features, numbers, step, operations, elements, parts, or combinations thereof may be added.

Hereinafter, embodiments of a braille slate according to the inventive concept will be described in detail with reference to the accompanying drawings, and in a description of the inventive concept with reference to the accompanying drawings, the same or corresponding elements will be endowed with the same reference numerals, and a repeated description thereof will be omitted.

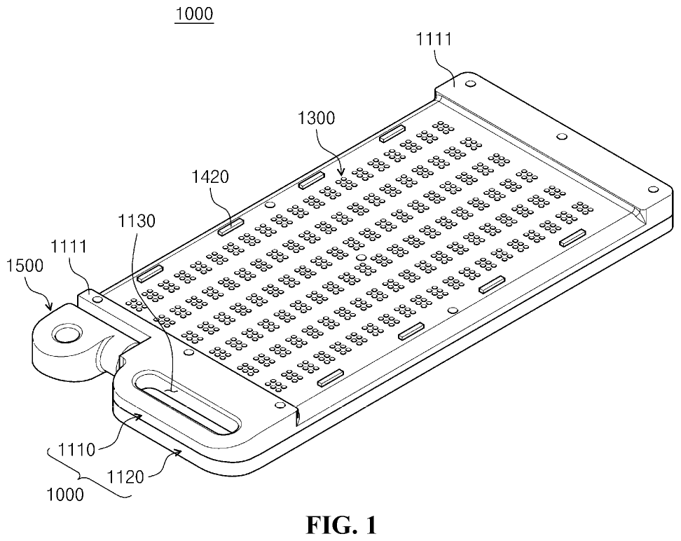

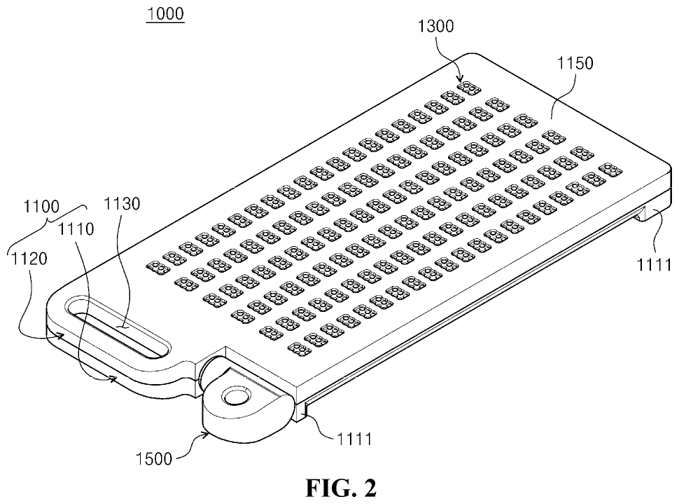

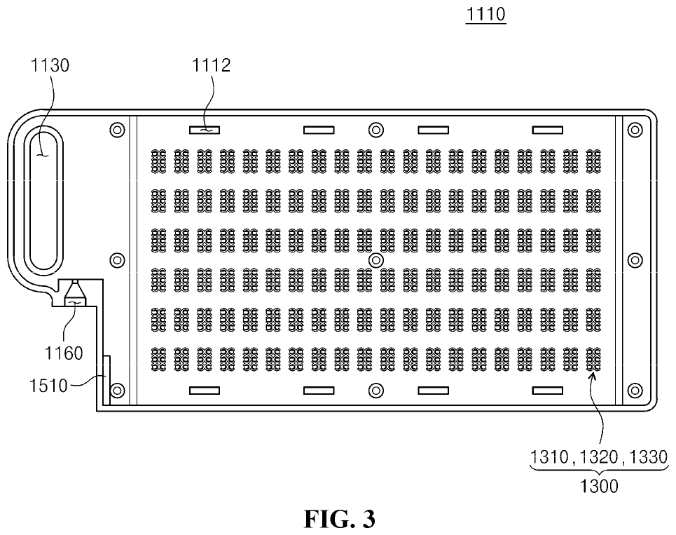

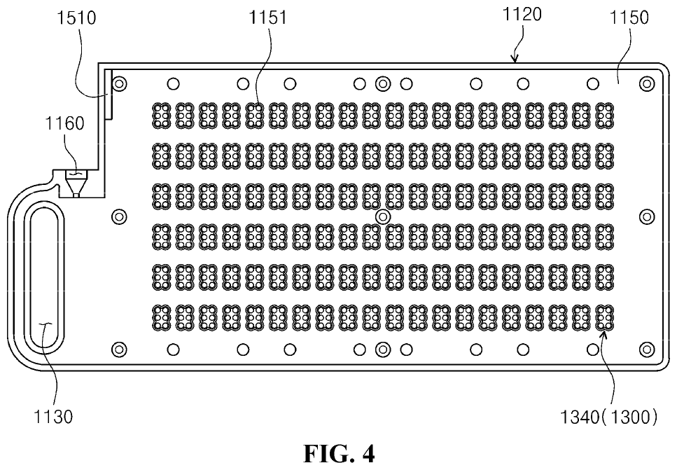

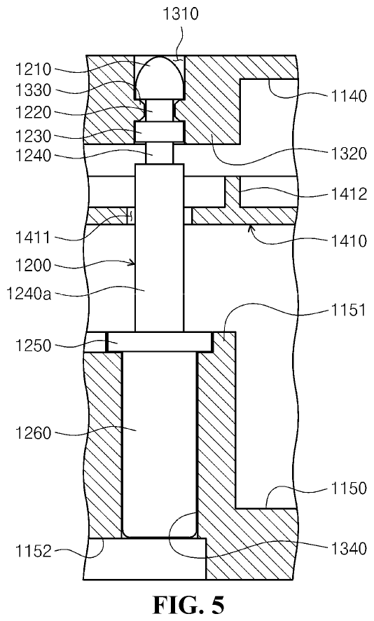

FIG. 1 is a perspective view illustrating one side wall 1140 of a braille slate 1000 according to an embodiment of the inventive concept. FIG. 2 is a perspective view illustrating an opposite side wall 1150 of the braille slate 1000 of FIG. 1. FIG. 3 is a plan view illustrating an interior of a first housing 1110 of FIG. 1. FIG. 4 is a plan view illustrating an interior of a second housing 1120 of FIG. 1. FIG. 5 is a side cross-sectional view illustrating a part of the braille slate 1000 of FIG. 1, which is cut such that a braille pin 1200 in an unlocked state is viewed;

Referring to FIGS. 1 to 5, the braille slate 1000 includes a housing 1100, a plurality of braille pins 1200, a plurality of braille pin pressing parts 1300, an unlocking member 1400, and a stylus 1500.

Configurations, except for the braille pins 1200 of the housing 1100 and an elastic member 1430, which will be described below, may be formed of a material having a flexibility, an elasticity, and an anti-impact property. For example, the configurations, except for the braille pins 1200 of the housing 1100 and the elastic member 1430, which will be described below, may be formed of a polycarbonate (PC) material.

The housing 1100 has a space in the interior thereof. According to an embodiment, the housing 1100 includes the first housing 1110 and the second housing 1120. The first housing 1110 and the second housing 1120 are combined with each other to form a space in an interior thereof. The first housing 1110 and the second housing 1120 may be coupled to each other by a bolt. The housing 1100 may have a grip hole 1130, by which one end of the housing 1100 may be easily gripped by a hand.

The first housing 1110 includes on one side wall 1140 and a support protrusion 1111. The second housing 1120 includes the opposite side wall 1150. The one side wall 1140 and the opposite side wall 1150 are surfaces of the housing 1100 that face opposite directions. The support protrusion 1111 protrudes outwards from the one side wall 1140. According to an embodiment, the support protrusion 1111 may have a bar shape that is parallel to one end and an opposite end of the one side wall. By providing the support protrusion 1111, protrusion of a head of the braille pin 1200 from the one side wall 1140 by a pressing operation of a user may be prevented from being hampered by a table or the like even when the one side wall 1140 of the braille slate 1000 faces the table or the like. The first housing 1110 may have a button hole 1112, through which an unlocking button 1420 passes, on the one side wall 1140.

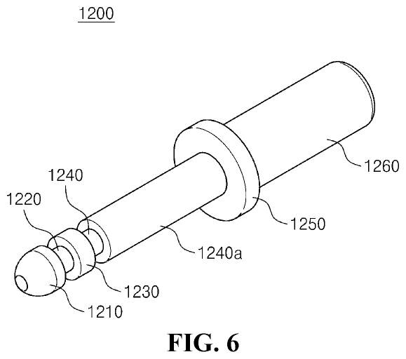

FIG. 6 is a perspective view of the braille pin 1200 illustrated in FIG. 5. Referring to FIGS. 5 and 6, the plurality of braille pins 1200 are disposed in rows and columns in the braille pin pressing parts 1300. For example, six braille pins 1200 may be included in one braille pin pressing part 1300 such that each of the braille pins 1200 represents one point. A head 1210 of the braille pin 1200, which will be described below, may face the one side wall 1140 of the housing 1100, and a leg 1260 may face the opposite side wall 1150. The braille pin 1200 is pressed through a pressing operation of the user and is locked on the braille pin pressing part 1300 such that one end thereof protrudes from the one side wall 1140 of the housing 1100. According to an embodiment, the braille pin 1200 includes the head 1210, a neck 1220, a shoulder 1230, a first body 1240, a second body 1240a, a waist 1250, and the leg 1260. The braille pin 1200 may be formed of a material having an anti-wear property, a low frictional coefficient, a high elasticity, and a high strength. For example, the braille pin 1200 may be formed of an acetal polyoxymethylene (POM).

The head 1210 is formed at one end of the braille pin 1200. The neck 1220 extends from the head 1210 in a direction toward the opposite side wall 1150 of the housing 1100. The shoulder 1230 extends from the neck 1220 in the direction toward the opposite side wall 1150. The first body 1240 extends from the shoulder 1230 in the direction toward the opposite side wall 1150. The second body 1240a extends from the first body 1240 in the direction toward the opposite side wall 1150. The waist 1250 extends from the second body 1240a in the direction toward the opposite side wall 1150. The leg 1260 extends from the waist 1250 in the direction toward the opposite side wall 1150.

The neck 1220 may be recessed more inwards than the head 1210. The shoulder 1230 may protrude more outwards than the neck 1220. The first body 1240 may be recessed more inwards than the shoulder 1230. The second body 1240a may protrude more outwards than the first body 1240, may be recessed more inwards than the shoulder 1230, and may be configured such that a side surface thereof coincides with a side surface of the shoulder 1230 when viewed along a lengthwise direction of the braille pin 1200. The waist 1250 may protrude more outwards than the second body 1240a such that an end thereof is located outwardly farther than an end of the shoulder 1230. The leg 1260 may be recessed more inwards than the waist 1250.

For example, the head 1210, the neck 1220, the shoulder 1230, the first body 1240, the second body 1240a, the waist 1250, and the leg 1260 may have concentric cylindrical shapes of different diameters. In this case, the neck 1220 may have a diameter that is smaller than that of the head 1210. The shoulder 1230 may have a diameter that is larger than that of the neck 1220. The first body 1240 may have a diameter that is smaller than that of the shoulder 1230. The second body 1240a may have a diameter that is larger than that of the first body 1240 and is smaller than or equal to that of the shoulder 1230. The waist 1250 may have a diameter that is larger than that of the shoulder 1230. The leg 1260 may have a diameter that is smaller than that of the waist 1250.

The configurations of a braille pin hole 1310, a braille pin through portion 1320, a locking boss 1330, and a braille pin window 1340, and the other configurations may have shapes corresponding to the shape of the braille pin 1200.

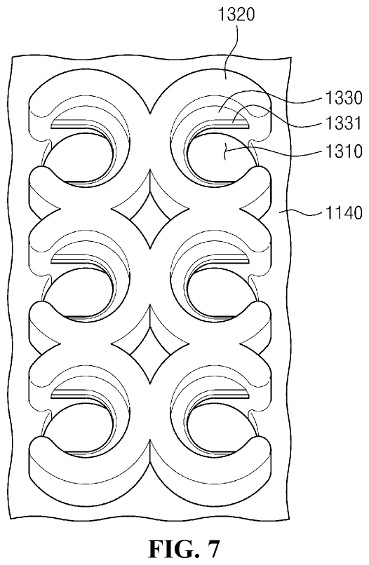

FIG. 7 is a perspective view illustrating the braille pin hole 1310, the braille pin through portion 1320, and the locking boss 1330 illustrated in FIG. 3. Referring to FIGS. 3, 5, and 7, the plurality of braille pin pressing parts 1300 are arranged in rows and columns in the housing 1100 when the one side wall 1140 of the housing 1100 is viewed. For example, the braille pin pressing parts 1300 may be provided in 6 columns and 20 rows. Unlike this, the braille pin pressing parts 1300 may be provided in various combinations of columns and rows. For example, the braille pin pressing parts 1300 may be provided in 5 columns and 20 rows. According to an embodiment, each of the braille pin pressing parts 1300 includes the braille pin hole 1310, the braille pin through portion 1320, the locking boss 1330, and the braille pin window 1340.

The braille pin hole 1310 is formed in the one side wall 1140 of the housing 1100 such that the head 1210 of the braille pin 1200 passes therethrough. A visually handicapped person recognizes a braille by detecting whether the head 1210 protrudes from the one side wall 1140 through the braille pin hole 1310 in a haptic manner.

The braille pin through portion 1320 extends from the one side wall 1140 of the housing 1100 in the direction toward the opposite side wall 1150, and surrounds the braille pin hole 1310. According to an embodiment, each braille pin through portion 1320 may have a shape that surrounds the braille pin hole 1310 when viewed from a direction toward the one side wall 1140. Further, according to an embodiment, each braille pin through portion 1320 may have a shape, a portion of which is cut away, when viewed from the direction toward the one side wall 1140. For example, the braille pin through portion 1320 may have a “C” shape when viewed from the direction which faces the one side wall 1140. Furthermore, for example, the braille pin through portion 1320 may have a plurality of shapes that are separated from each other when viewed from the direction which faces the one side wall 1140. Accordingly, the braille pin through portion 1320 may be widened more flexibly such that the head 1210 passes by the locking boss 1330 for locking or unlocking.

The locking boss 1330 protrudes from an inner surface of the braille pin through portion 1320. The braille pin 1200 is locked as the first body 1240 is engaged with the locking boss 1330. That is, the braille pin 1200 may be locked as the first body 1240 is engaged with the locking boss 1330 and may maintain the locking state as the shoulder 1230 and the second body 1240a is caught by the locking boss 1330. The locking boss 1330 may be formed along a circumferential direction of the inner surface of the braille pin through portion 1320. Furthermore, in a state in which the braille pin 1200 is unlocked, the neck 1220 is engaged with the locking boss 1330.

The locking boss 1330 may have an inclined surface 1331, by which the locking boss 1330 is inclined to be thinner as it goes in a protruding direction, at a corner of an end in the protruding direction. By providing the inclined surface 1331, the head 1210 may pass by the locking boss 1330 more easily for locking and unlocking of the braille pin 1200.

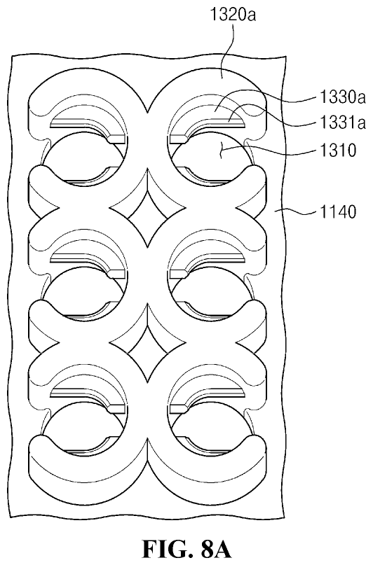

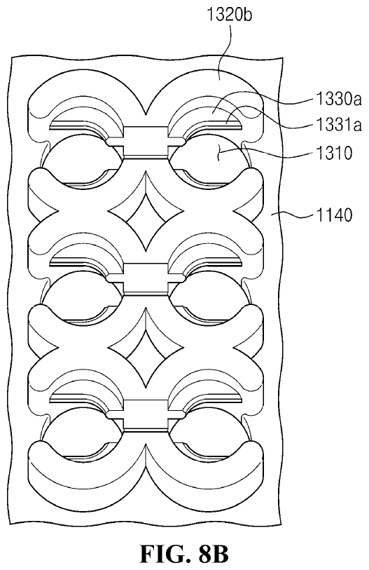

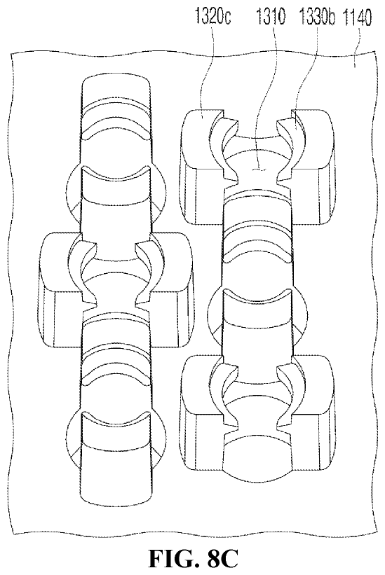

FIG. 8A is a perspective view illustrating another example of the braille pin hole 1310, a braille pin through portion 1320a, and a locking boss 1330a illustrated in FIG. 3. Referring to FIG. 8A, according to the present embodiment, the locking boss 1330a may have a shape, a portion of which is cut away, when viewed from the direction toward the one side wall 1140. Accordingly, the locking boss 1330a and the braille pin through portion 1320a may be widened more flexibly such that the head 1210 passes by the locking boss 1330a for locking or unlocking.

FIG. 8B is a perspective view illustrating still another example of the braille pin hole 1310, a braille pin through portion 1320b, and the locking boss 1330a illustrated in FIG. 3. Referring to FIG. 8B, the braille pin through portion 1320b may have a shape, of which a portion that is not the above-described portion, is cut away. For example, when the braille pin through portion 1320b has a “C” shape as described above, connected area of the braille pin through portions 1320b, which are adjacent to each other such that the above-described portions thereof face opposite directions, may be cut away.

FIG. 8C is a perspective view illustrating yet another example of the braille pin hole 1310, a braille pin through portion 1320c, and a locking boss 1330b illustrated in FIG. 3. Referring to FIG. 8C, the braille pin through portion 1320c may have a shape, of which a portion that is not the above-described portion, is cut away. For example, when the braille pin through portion 1320c has a plurality of shapes that are separated as described above, the adjacent braille pin through portions 1320c may not be connected to each other but may be skewed. According to the present embodiment, when the braille pin through portion 1320c has two shapes that are separated, the adjacent braille pin through portions 1320c may not be connected to each other but may be skewed in a vertical direction.

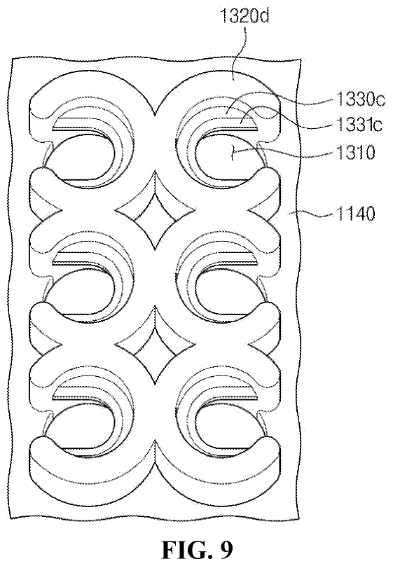

FIG. 9 is a perspective view illustrating still yet another example of the braille pin hole 1310, a braille pin through portion 1320d, and a locking boss 1330c illustrated in FIG. 3. Referring to FIG. 9, according to the present embodiment, an inclination and/or a width of a inclined surface 1331c may be differently provided if necessary.

As described above, because whether a portion of the locking boss 1330, 1330a, 1330b, and 1330c is cut away, and an inclination and/or a width of the inclined surface 1331, 1331a, 1331b, and 1331c are differently determined, a force that presses the braille pin 1200 by the user, which is required for locking the braille pin 1200 and/or a force that presses the unlocking button 1420 by the user, which is required for unlocking the braille pin 1200 may be adjusted.

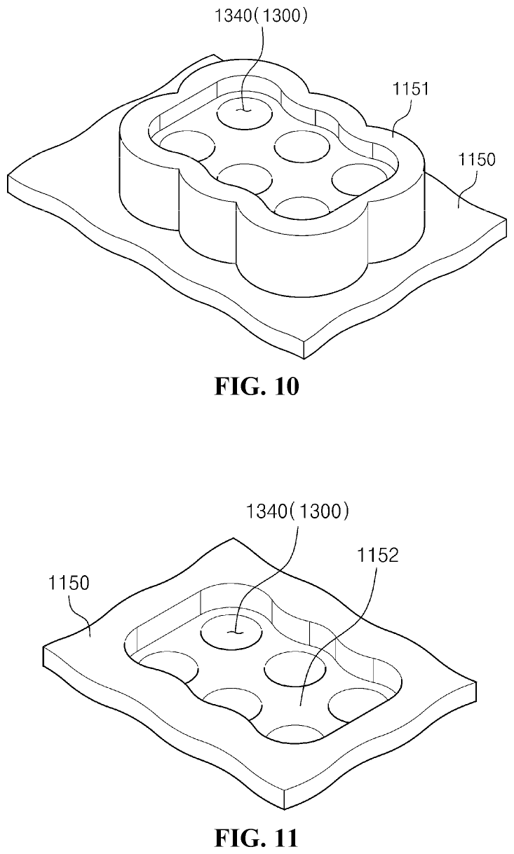

FIG. 10 is a perspective view illustrating a state, in which the braille pin window 1340 illustrated in FIG. 2 is viewed from an inner side. FIG. 11 is a perspective view illustrating a state, in which the braille pin window 1340 illustrated in FIG. 2 is viewed from an outer side. Referring to FIGS. 5, 10, and 11, the braille pin window 1340 is formed in the opposite side wall of the housing 1100. The leg 1260 is inserted into the braille pin window 1340. The braille pin window 1340 is formed to pass through inner and outer sides of the housing 1100. The user locks the braille pin 1200 by pressing the braille pin 1200 through the braille pin window 1340 from the outside of the housing 1100 by using the stylus 1500. The braille pin window 1340 is sized such that the leg 1260 may be inserted therethrough and the waist 1250 may be caught thereby. Accordingly, the braille pin 1200 may be prevented from being discharged to the outside through the braille pin window 1340 due to the waist 1250.

According to an embodiment, a support 1151 extending in a direction toward the one side wall 1140 to surround the braille pin window 1340 included in the braille pin pressing part 1300 may be formed in the opposite side wall 1150 of the housing 1100. The support 1151 may be sized such that a hole formed by an inner surface thereof contacts or is adjacent to a side surface of the waist 1250 in a state, in which the leg 1260 is inserted into the braille pin window 1340. Accordingly, because the braille pin 1200 is dually supported laterally by the braille pin window 1340 that surrounds the leg 1260 and the support 1151 that surrounds the waist 1250 when the braille pin 1200 is arranged in the second housing 1120 by inserting the leg 1260 into the braille pin window 1340 before the unlocking member 1400 and the first housing 1110 are assembled in the process of assembling the braille slate 1000, the braille pin 1200 may be stably arranged in the second housing 1120 while the unlocking member 1400 and the first housing 1110 are assembled.

According to an embodiment, a recess 1152 that is formed by recessing an area including the area, in which the braille pin window 1340 included in each of the braille pin pressing parts 1300 is formed, may be provided on an outer surface of the opposite side wall 1150 of the housing 1100. The inner surface of the recess 1152 may have a wave shape to correspond to the braille pin window. Accordingly, the user may precisely identify a location of the braille pin window 1340 that is to be pressed, by identifying the wave shape in a haptic manner without visually identifying it.

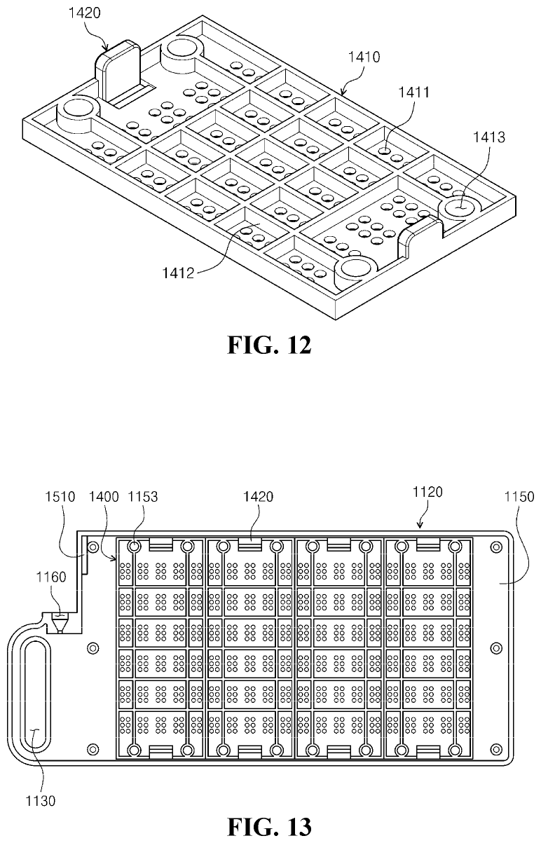

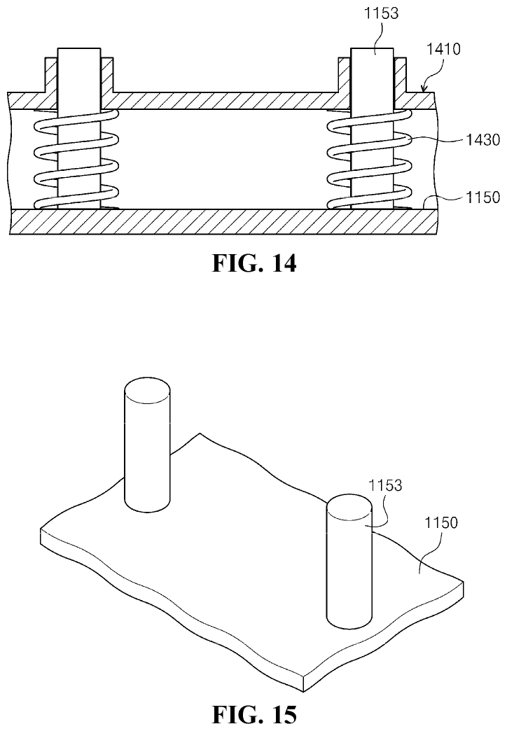

FIG. 12 is a perspective view illustrating an example of an unlocking plate 1410 illustrated in FIG. 5. FIG. 13 is a perspective view illustrating an example of a state, in which the unlocking plate 1410 of FIG. 12 is disposed in the second housing 1120. FIG. 14 is a side cross-sectional view illustrating a part of the braille slate 1000 of FIG. 1, which is cut such that the unlocking plate 1410 in a raised state is viewed. Referring to FIGS. 5, and 12 to 14, the unlocking member 1400 unlocks the braille pin 1200 by applying a force to the braille pin 1200 in the direction toward the opposite side wall 1150 of the housing 1100 and moving the braille pin 1200 in the direction toward the opposite side wall 1150 in a state, in which the braille pin 1200 is locked. According to an embodiment, the unlocking member 1400 includes the unlocking plate 1410, the unlocking button 1420, and the elastic member 1430.

A plurality of unlocking members 1400 may be provided to correspond to a plurality of areas obtained by dividing the area, in which the braille pin pressing part 1300 of the housing 1100 is disposed. According to an embodiment, the plurality of unlocking members 1400 may be arranged side by side along a direction that is perpendicular to a direction, in which the unlocking buttons 1420 provided at opposite ends of the housing 1100 are arranged. Accordingly, the user may write words or sentences of different contents for areas corresponding to the unlocking buttons 1420, and it may be selected whether the written words or sentences are to be reset according to the areas corresponding to the unlocking buttons 1420.

Through-holes 1411, through which the braille pins 1200 pass, are formed in the unlocking plate 1410. The unlocking plate 1410 is located between the braille pin through portions 1300 and the waists 1250. Opposite ends of the unlocking plate 1410 may be provided to correspond to one end area and an opposite end area of an edge area that surrounds the area, in which the braille pin pressing parts 1300 of the housing 1100 are disposed. The opposite end area is an area that is opposite to the one end area of the edge area.

The through-hole 1411 is sized such that the head 1210, the shoulder 1230, and the second body 1240a pass therethrough and the waist 1250 is caught thereby. Accordingly, when the braille slate 1000 is assembled or the braille pin 1200 is moved for locking and unlocking, the braille pin 1200 may be moved while the head 1210, the shoulder 1230, and the second body 1240a, and the unlocking plate 1410 do not interfere with each other, and the braille pin 1200 may be moved by applying a force to the waist 1250 in the direction toward the opposite side wall 1150 by the unlocking plate 1410 for unlocking.

A rib 1412 that extends from a surface facing the one side wall 1140 along an area, except for the area corresponding to the braille pin pressing part 1300 may be provided in the unlocking plate 1410. A strength of the unlocking plate 1410 may be reinforced by providing the rib 1412.

The unlocking button 1420 extends to pass through the one side wall 1140 from the unlocking plate 1410 to protrude to the outside. Accordingly, when the user presses the unlocking button 1420, the braille pins 1200 are unlocked while the unlocking plate 1410 is moved in the direction toward the opposite side wall 1150. According to an embodiment, the unlocking buttons 1420 may be formed at opposite ends of the unlocking plate 1410. Furthermore, when the unlocking members 1400 are arranged in a direction that is perpendicular to the direction, in which the unlocking buttons 1420 are arranged, a distance between the adjacent unlocking members 1400 becomes larger as compared with the case the unlocking members 1400 are arranged in the direction, in which the unlocking buttons 1420 are arranged, whereby a possibility of pressing the unlocking button 1420 other than the unlocking button 1420 in the area that is to be reset.

FIG. 15 is a perspective view illustrating a guide 1153 illustrated in FIG. 4. Referring to FIGS. 12, 14, and 15, according to an embodiment, the guide 1153 that extends in the direction toward the one side wall 1140 may be formed in the opposite side wall of the housing 1100.

Furthermore, a guide hole 1413, through which the guide 1153 passes, may be formed in the unlocking plate 1410 such that the unlocking plate 1410 is moved along the guide 1153.

The guide 1153 may be integrally formed with the housing 1100. Accordingly, the manufacturing process is simplified and manufacturing costs are reduced as compared with the case in which the guide 1153 is manufactured separately from the housing 1100 and undergoes a separate assembling process, whereby an error rate due to an accumulated tolerance due to use of several components may be reduced.

The elastic member 1430 applied an elastic force to the unlocking plate 1410 in the direction toward the one side wall 1140. For example, the elastic member 1430 may be a coil spring that surrounds the guide 1153, between the unlocking plate 1410 and the opposite side wall 1150 of the housing 1100. The coil spring may be formed of a metallic material having a sufficient elasticity.

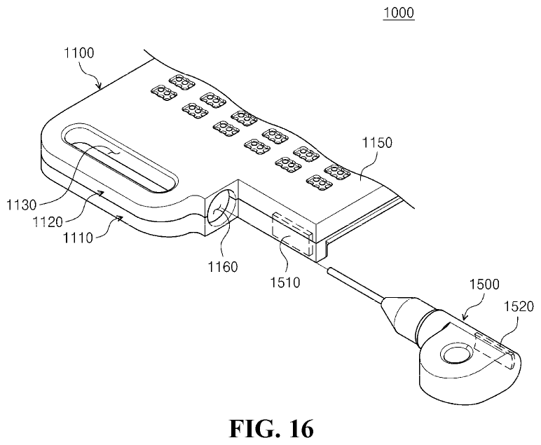

FIG. 16 is a partially perspective view illustrated an example of a stylus 1500 and a stylus hole 1160 illustrated in FIG. 2. Referring to FIG. 16, the user locks the braille pin 1200 by inserting a pin part of the stylus 1500 into the braille pin window 1340 and pressing the braille pin 1200. The stylus 1500 may be inserted into the stylus hole 1160 formed in the housing 1100 and may be preserved.

Magnets, opposite poles of which face each other such that an attractive force is applied therebetween, may be provided in one side area 1520 of the area, in which the stylus 1500 is inserted into the stylus hole 1160, and an area 1510 corresponding to the one side hole of the stylus hole 1160 of the housing 1100, or a magnet may be provided in one of the areas and a steel member may be provided in the other of the areas. Accordingly, the stylus 1500 may be guided to be always inserted in the same direction when being inserted into the stylus hole 1160, and the stylus 1500 may maintain the state, in which the stylus 1500 is inserted into the stylus hole 1160, unless a force or more is not applied to the stylus 1500 in the state, in which the stylus 1500 is inserted into the stylus hole 1160.

Hereinafter, a process of assembling the braille slate 1000 of FIG. 1 will be described. Referring to FIGS. 5 and 14, the second housing 1120 is seated such that the inner surface thereof faces a top. Thereafter, the braille pin 1200 is located such that the leg 1260 is inserted into the braille pin window 1340. Furthermore, the elastic member 1430 that is a spring is located to surround the guide 1153. Then, when a plurality of unlocking plates 1410 are provided to divide the area, in which the braille pin pressing parts 1300 of the second housing 1120 are provided, the elastic members are located to surround all the guides 1153 corresponding to all the divided areas. Thereafter, the unlocking plate 1410 covers an upper side of the second housing 1120 such that the through-hole 1411 is passed through by the braille pin 1200 positioned in the braille pin window 1340 and the guide hole 1413 is passed through by the guide 1153. Then, when a plurality of unlocking plates 1410 are provided to divide the area, in which the braille pin pressing parts 1300 of the second housing 1120 are provided, the plurality of unlocking plates 1410 cover the upper side of the second housing 1120 such that all the divided areas are covered. Thereafter, the second housing 1120 is covered by the first housing 1110 such that the inner surface of the first housing 1110 faces the inner side of the second housing 1120, and the first housing 1110 and the second housing 1120 are coupled to each other by using a coupling member such as a bolt.

Hereinafter, a method for locking and unlocking the braille pin in the braille slate 1000 of FIG. 1 will be described.

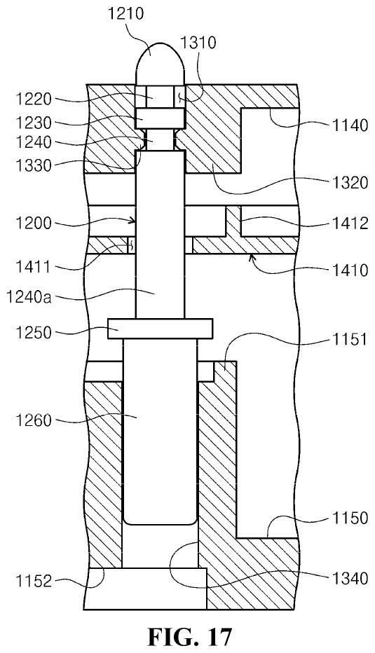

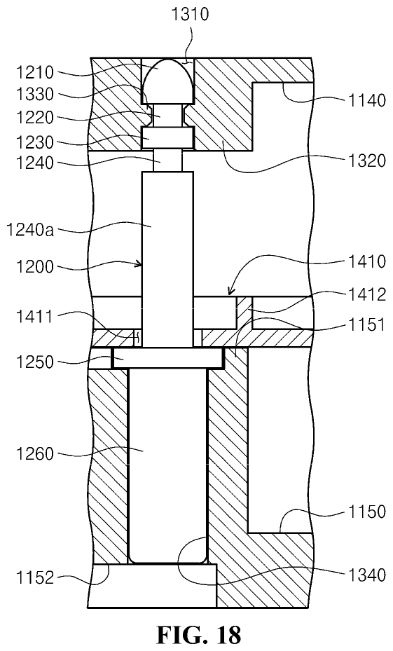

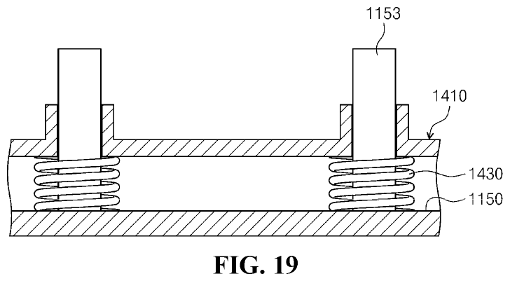

FIG. 17 is a side cross-sectional view illustrating a part of the braille slate 1000 of FIG. 1, which is cut such that the braille pin 1200 in a locked state is viewed. FIG. 18 is a side cross-sectional view illustrating a part of the braille slate 1000 of FIG. 1, which is cut such that the braille pin 1200 unlocked by the unlocking plate 1410 is viewed. FIG. 19 is a side cross-sectional view illustrating a part of the braille slate 1000 of FIG. 1, which is cut such that the unlocking plate 1410 in a lowered state is viewed.

Referring to FIGS. 5 and 14 again, in the unlocked state, the leg 1260 of the braille pin 1200 is inserted into the braille pin window 1340, and the waist 1250 is positioned on the support 1151 that surrounds a circumference of the braille pin window 1340 in a supported state. Further, the neck 1220 is engaged with the locking boss 1330. Then, the unlocking plate 1410 is located at an upper location that is spaced apart from the waist 1250 by the elastic member 1430.

Referring to FIG. 17, when the user presses the braille pin 1200 through the braille pin window 1340 by using the stylus 1500 in the states of FIGS. 5 and 14, the braille pin 1200 is moved in the direction toward the one side wall 1140 and the first body 1240 is engaged with the locking boss 1330 and the braille pin 1200 is locked. Then, because the through-hole 1411 is sized such that the second body 1240a may pass therethrough, the second body 1240a is not moved together with the braille pin 1200 as the braille pin 1200 is moved, but maintains the states of FIGS. 5 and 14.

Referring to FIGS. 18 and 19, because the unlocking plate 1410 is moved in the direction toward the opposite side wall 1150 and the through-hole 1411 is sized such that the waist 1250 cannot pass therethrough when the user presses the unlocking button 1420 in the state of FIG. 17, the braille pin 1200 is moved in the direction toward the opposite side wall 1150 by the force applied by the unlocking plate 1410 and is unlocked. Thereafter, when the user releases the force that presses the button, the unlocking plate 1410 returns to the location illustrated in FIGS. 5 and 14 by the elastic force of the elastic member 1430.

As described above, according to the braille slate 1000 according to the embodiment of the inventive concept, a visually handicapped person may use the braille slate 1000 to read and write a braille without using separate paper by locking and unlocking the braille pin 1200, the input braille may be initialized, and a typo of the braille may be immediately corrected. Because the braille slate 1000 follows a general braille reading/writing principle, the user may write a braille by locking and unlocking the braille pin 1200 of the braille slate 1000 and then turn the braille slate 1000 over to read the recorded contents.

In more detail, when the braille is recorded, the braille slate 1000 may be disposed such that a surface, on which the braille pin 1200 is pressed, faces the top (an opposite side surface). The pressed braille pin 1200 may protrude to face the bottom (one side surface) to be locked. Furthermore, the locked braille pin 1200 may be unlocked to be corrected.

When the braille is read, the braille slate 1000 disposed before is turned over. Accordingly, the surface, on which the braille pin 1200 is pressed, is disposed to face the bottom (the opposite side surface) and the locked braille pin 1200 protrudes to face the top (the one side surface) and is fixed, whereby the user may read the locked braille pin 1200 with a hand.

When the user presses the unlocking button 1420 provided in the braille slate 1000 to erase the braille, the unlocking plate 1410 is moved from the one side wall toward the opposite side wall, and the locked braille pin 1200 may be moved from the one side wall toward the opposite side wall by the force applied by the unlocking plate 1410 to be unlocked. Thereafter, when the user releases the force that presses the button 1420, the unlocking plate 1410 may return to the original position by the elastic force of the elastic member 1430.

Furthermore, according to the braille slate 1000 according to the embodiment of the inventive concept, because the written contents may be maintained until the braille pin 1200 is unlocked by locking the shoulder 1230 and the second body 1240a in the locked state of the braille pin 1200 and may be corrected as described above, a menu plate for visually handicapped person may be used in restaurants.

Although the preferred embodiment of the inventive concept has been described until now, it can be understood by an ordinary person in the art that the inventive concept may be variously corrected and changed without departing from the spirit and area of the inventive concept described in the claims.

[Description of reference numerals]

| | |
|---|---|
| 1000: | braille slate |
| 1100: | housing |
| 1110: | first housing |
| 1120: | second housing |
| 1140: | one side wall |
| 1150: | opposite side wall |
| 1151: | support |
| 1152: | recess |
| 1153: | guide |
| 1160: | stylus hole |
| 1200: | braille pin |
| 1210: | head |
| 1220: | neck |
| 1230: | shoulder |
| 1240: | first body |
| 1240a: | second body |
| 1250: | waist |
| 1260: | leg |
| 1300: | braille pin pressing part |
| 1310: | braille pin hole |
| 1320: | braille pin through portion |
| 1330: | locking boss |
| 1331: | inclined surface |
| 1340: | braille pin window |
| 1400: | unlocking member |
| 1410: | unlocking plate |
| 1411: | through-hole |
| 1412: | rib |
| 1413: | guide hole |
| 1420: | unlocking button |
| 1430: | elastic member |

1. A braille slate comprising:
a housing having a space in an interior thereof;
a plurality of braille pin pressing parts disposed in rows and columns when one side wall of the housing is viewed;
a plurality of braille pins disposed in rows and columns in the braille pin pressing parts and pressed through a pressing operation from an opposite side wall toward the one side wall of the housing to be locked on the braille pin pressing parts such that ends thereof protrude from the one side wall of the housing;
a stylus separately provided on an outer side of the housing and configured to perform a pressing operation of pressing the braille pins; and
an unlocking member configured to unlock the braille pins by applying a force from the one side wall toward the opposite side wall to move the braille pins toward the opposite side wall in a state, in which the braille pins are locked.

2. The braille slate of claim 1, wherein each of the braille pins includes:
a head formed at the end thereof;
a neck extending from the head in a direction toward the opposite side wall and recessed more inwards than the head;
a shoulder extending from the neck in the direction toward the opposite side wall and protruding more outwards than the neck;
a first body extending from the shoulder in the direction toward the opposite side wall and recessed more inwards than the shoulder;
a second body extending from the first body in the direction toward the opposite side wall and protruding more outwards than the first body;
a waist extending from the second body in the direction toward the opposite side wall; and
a leg extending from the waist in the direction toward the opposite side wall and recessed more inwards than the waist,
wherein the braille pin pressing part includes:
a braille pin hole formed on the one side wall such that the head passes therethrough;
a braille pin through portion extending from the one side wall in the direction toward the opposite side wall and surrounding the braille pin hole;
a locking boss protruding from an inner surface of the braille pin through portion; and
a braille pin window formed such that the leg is inserted into the opposite side wall and inner and outer sides of which are passed through,
wherein the braille pin window is sized such that the leg is inserted thereinto and the waist is caught thereby, and
wherein the first body is engaged with the locking boss in the state, in which the braille pin is locked, and the neck is engaged with the locking boss in a state, in which the braille pin is unlocked.

3. The braille slate of claim 2, wherein the locking boss has an inclined surface, by which the locking boss is inclined to be thinner as it goes in a protruding direction, at a corner of an end in the protruding direction.

4. The braille slate of claim 2, wherein the second body is recessed more inwards than the shoulder or a side surface of the second body coincides with a side surface of the shoulder when viewed along a lengthwise direction of the braille pin,
wherein an end of the waist protrudes more outwards than the second body to be located outwardly farther than an end of the shoulder,
wherein the unlocking member includes:
an unlocking plate having a through-hole, through which the braille pin passes, and located between the braille pin through portion and the waist;
an unlocking button extending to pass through the one side wall from the unlocking plate and protrudes outwards; and
an elastic member configured to apply an elastic force to the unlocking plate in a direction toward the one side wall, and
wherein the through-hole is sized such that the head, the shoulder, and the second body pass therethrough and the waist is caught thereby.

5. The braille slate of claim 4, wherein opposite ends of the unlocking plate correspond to one end area of an edge area of the housing, which surrounds an area in which the braille pin pressing parts are disposed, and an opposite end area that is an opposite area to the one end area, and
wherein the unlocking buttons are formed at the opposite ends of the unlocking plate.

6. The braille slate of claim 4, wherein a rib extending from a surface facing the one side wall along an area, except for an area corresponding to the braille pin pressing parts, is provided in the unlocking plate.

7. The braille slate of claim 4, wherein a plurality of unlocking members are provided to correspond to a plurality of areas obtained by dividing the area of the housing, in which the braille pin pressing parts are disposed.

8. The braille slate of claim 4, wherein a guide extending in the direction toward the one side wall is formed in the opposite side wall,
wherein a guide hole, through which the guide passes, is formed in the unlocking plate such that the unlocking plate is moved along the guide, and
wherein the guide is integrally formed with the housing.

9. The braille slate of claim 2, wherein a support extending in a direction toward the one side wall to surround the braille pin window included in the braille pin pressing part is formed in the opposite side wall, and
wherein the support is sized such that a hole formed by an inner surface thereof contacts or is adjacent to a side surface of the waist in a state, in which the leg is inserted into the braille pin window.
